(19) United States
(12) Patent Application Publication
(10) Pub. No.: US 2025/0387939 A1
(43) Pub. Date: Dec. 25, 2025

(54) MEDIUM PROCESSING DEVICE

(71) Applicant: CASIO COMPUTER CO., LTD., Tokyo (JP)

(72) Inventors: Masakazu SUZUKI, Tokyo (JP); Masatoshi MARUYAMA, Tokyo (JP)

(73) Assignee: CASIO COMPUTER CO., LTD., Tokyo (JP)

(21) Appl. No.: 19/215,518

(22) Filed: May 22, 2025

(30) Foreign Application Priority Data
Jun. 20, 2024 (JP) 2024-099300

(51) Int. Cl. B26D 7/26; B26D 1/12

(52) U.S. Cl. CPC B26D 7/2628; B26D 1/125

(57) ABSTRACT

A medium processing device (10) includes: a processing unit (56) that presses and processes a sheet-like medium (S); a processing-unit driving mechanism (20) that can execute a first operation of moving the processing unit 856) in a first direction (X) along a sheet surface (S1) of the medium (S) and a second operation of changing a height position of the processing unit (56) from the sheet surface (S1); and a relative moving mechanism (18) that relatively moves the medium (S) with respect to the processing unit (56) in a second direction (Y), wherein the processing-unit driving mechanism (20) includes: a guide member (21) guides the processing unit (56) so as to be movable in the first direction (X); and a support shaft (25, 26) disposed at a position closer to the medium than the guide member (21) and having the first direction (X) as a shaft center (C1), and the second operation is set as an operation of integrally changing a height position of the processing unit (56) from the sheet surface (S) with the guide member (21) along with rotation of the support shaft (25, 26) about the shaft center (C1).

### CROSS-REFERENCE TO RELATED APPLICATIONS

This application claims the priority and benefit of Japanese Patent Application No. 2024-099300 filed on Jun. 20, 2024. The entire specification, claims, and drawings of Japanese Patent Application No. 2024-099300 are incorporated herein by reference.

### TECHNICAL FIELD

The present disclosure relates to a medium processing device.

### RELATED ART

As a processing device that processes a sheet-like medium, a cutting device that performs cutting processing on a medium is known (for example, JP 2013-193192 A). The cutting device conveys the medium in a predetermined direction based on cutting data, and performs control to move a cutting cutter in a direction orthogonal to the conveyance direction of the medium to cut the medium into a predetermined shape (figure, character, or the like).

This type of processing device can perform various types of processing on the medium by selecting the type of processing unit (processing tool). For example, by attaching a writing implement instead of a cutter, it can be used as a processing device for drawing.

### SUMMARY OF THE INVENTION

A medium processing device according to an aspect of the present disclosure is characterizes as including: a processing unit that presses and processes a sheet-like medium; a processing-unit driving mechanism that can execute a first operation of moving the processing unit in a first direction along a sheet surface of the medium and a second operation of changing a height position of the processing unit from the sheet surface; and a relative moving mechanism that relatively moves the medium with respect to the processing unit in a second direction intersecting the first direction, wherein the processing-unit driving mechanism includes: a guide member extending in the first direction, to which the processing unit is attached, and that guides the processing unit so as to be movable in the first direction; and a support shaft disposed at a position closer to the medium than the guide member in a height direction perpendicular to the sheet surface and having the first direction as a shaft center, and the second operation is set as an operation of integrally changing a height position of the processing unit from the sheet surface with the guide member along with rotation of the support shaft about the shaft center.

### BRIEF DESCRIPTION OF THE DRAWINGS

FIG. 1 is a perspective view of a medium processing device;

FIG. 2 is a front view of the medium processing device;

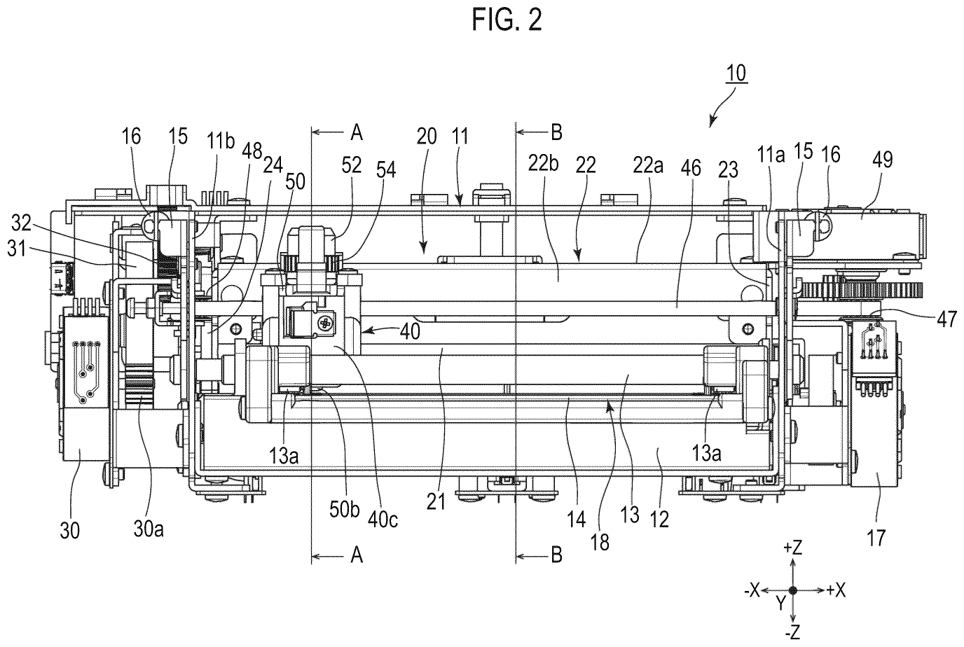

FIG. 3 is a perspective view of the medium processing device in a state in which the medium conveying mechanism is removed;

FIG. 4 is a perspective view of the medium processing device in a state in which the medium conveying mechanism is removed;

FIG. 5 is a perspective view illustrating a processing-unit driving mechanism and a carriage;

FIG. 6 is a perspective view illustrating the processing-unit driving mechanism;

FIG. 7 is a perspective view illustrating connection plates on both sides included in the processing-unit driving mechanism;

FIG. 8 is a cross-sectional view of the processing-unit driving mechanism and the carriage taken along line A-A in FIG. 2;

FIG. 9 is a cross-sectional view of the medium processing device in a state where the carriage is at the processing position at a position of a line B-B in FIG. 2;

FIG. 10 is a cross-sectional view of the medium processing device in a state where the carriage is at a retracted position at a position of a line B-B in FIG. 2;

FIG. 11 is a conceptual diagram illustrating a load acting on a knife at the time of processing;

FIG. 12 is a conceptual diagram illustrating a comparative example having a different arrangement of the rotation center of a second operation;

FIG. 13 is a conceptual diagram illustrating an arrangement of rotation centers of the second operation in the embodiment;

FIG. 14 is a conceptual diagram illustrating an arrangement of rotation centers of the second operation in a modification; and

FIG. 15 is a conceptual diagram illustrating an arrangement of rotation centers of the second operation in the modification.

### DETAILED DESCRIPTION

In the processing device, the processing unit is configured to approach and separate from the medium, the processing unit is brought close to the medium in a region where the processing unit processes the medium (perform cutting, drawing, and the like), and the processing unit is separated from the medium in a region where the processing unit does not process the medium. Therefore, it is necessary to cause the processing unit to perform a feeding operation in a direction intersecting the conveyance direction of the medium and a contacting/separating operation in a direction changing the distance to the medium. In the conventional processing device, there is a problem that a structure for causing the processing unit to perform such operations in a plurality of directions becomes complicated.

An object of the present disclosure is to provide a medium processing device that operates a processing unit with a simple structure and with high accuracy.

Hereinafter, embodiments of the present disclosure will be described in detail with reference to the drawings. The X-axis direction, the Y-axis direction, and the Z-axis direction illustrated in each drawing are directions perpendicular to each other. In a state where a medium processing device 10 according to the present embodiment is placed on a horizontal placement surface, the X-axis direction and the Y-axis direction are horizontal directions, and the Z-axis direction is a vertical direction (height direction of the medium processing device 10). In addition, the +Z direction side is an upper side, and the −Z direction side is a lower side. The present embodiment has a concept in which the X-axis direction is a first direction, the Y-axis direction is a second direction, and the first direction and the second direction include both forward and reverse directions (+, −). In the Y-axis direction, the +Y direction is a third direction, and the −Y direction is a fourth direction.

The medium processing device 10 presses the processing unit against a sheet surface S1, which is the upper surface of a sheet-like workpiece medium S (medium), to perform predetermined processing on the workpiece medium S. In the medium processing device 10, a first operation of moving the processing unit in the X-axis direction (first direction) along the sheet surface S1 of the workpiece medium S, an operation of relatively moving the workpiece medium S with respect to the processing unit in the Y-axis direction (second direction) intersecting the X-axis direction, and a second operation of changing the height position of the processing unit from the sheet surface S1 of the workpiece medium S (distance in the Z-axis direction with respect to the sheet surface S1) can be combined to perform processing on the workpiece medium S in an arbitrary trajectory.

The workpiece medium S is supplied to the medium processing device 10 in an overlapping manner on a mount T. Even when the mount T is not mentioned in the following description, the workpiece medium S is conveyed or processed in a state of overlapping with the mount T. The medium processing device 10 is configured by assembling each component to a main body 11. The medium processing device 10 may include an exterior member that covers the outside of the main body 11. The main body 11 includes a pair of side plates 11a and 11b disposed at an interval in the X-axis direction, and an inner plate 11c extending in the X-axis direction and connecting the pair of side plates 11a and 11b. On the −Y direction side of the main body 11, a tray 12 which is a pedestal on which the workpiece medium S is placed is provided.

A conveying roller 13 and a conveying roller 14 extending in the X-axis direction are supported between the pair of side plates 11a and 11b. The conveying roller 13 and the conveying roller 14 are arranged side by side in the Z-axis direction, and are both rotatable about a shaft center extending in the X-axis direction. The conveying roller 13 arranged on the +Z direction side is supported by a pair of roller support plates 15 on both sides rotatable with respect to the side plate 11a and the side plate 11b, and the distance between the conveying roller 13 and the conveying roller 14 in the Z-axis direction is changed by the rotation of the pair of roller support plates 15.

In a state where the conveying roller 13 is close to the conveying roller 14, the workpiece medium S can be sandwiched between a large-diameter pinching portion 13a of the conveying roller 13 and a pinching portion 14a of the conveying roller 14. A roller biasing spring 16 is connected to each of the pair of roller support plates 15, and the conveying roller 13 is biased in a direction approaching the conveying roller 14 (a direction sandwiching the workpiece medium S) by a biasing force of the roller biasing spring 16.

The conveying roller 14 arranged on the −Z direction side is rotated by the driving force generated by a roller driving motor 17 attached to the side portion of the side plate 11a. When the conveying roller 14 is rotated with the workpiece medium S sandwiched between the pinching portion 13a and the pinching portion 14a, the workpiece medium S is conveyed in the Y-axis direction. The conveyance direction of the workpiece medium S in the Y-axis direction can be switched by controlling the roller driving motor 17 to switch the rotation direction of the conveying roller 14. At least the conveying roller 13, the conveying roller 14, and the roller driving motor 17 constitute a medium conveying mechanism 18 that conveys the workpiece medium S in the Y-axis direction.

A support plate 19 is attached to the upper surface of the inner plate 11c of the main body 11. The support plate 19 is a plate-shaped member whose longitudinal direction is oriented in the X-axis direction. The workpiece medium S conveyed by the medium conveying mechanism 18 is supported on the support plate 19 and moves in the Y-axis direction while keeping the sheet surface S1 substantially horizontal. A region where the workpiece medium S is supported in the X-axis direction is defined as a medium supporting region. In the present embodiment, the medium supporting region can also be referred to as a region through which the workpiece medium S conveyed by the medium conveying mechanism 18 passes.

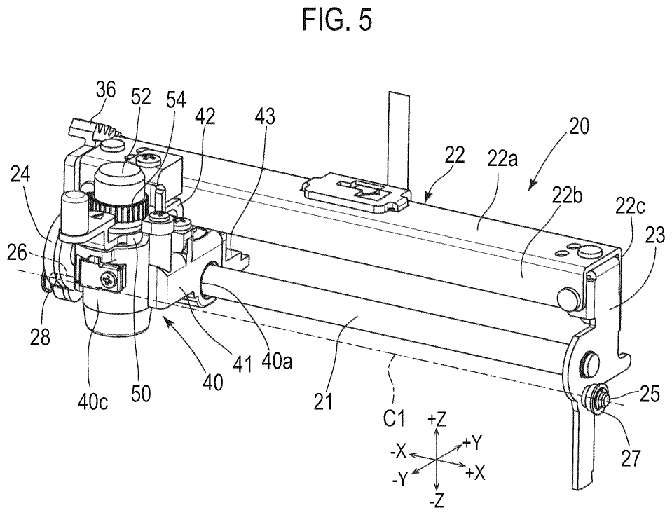

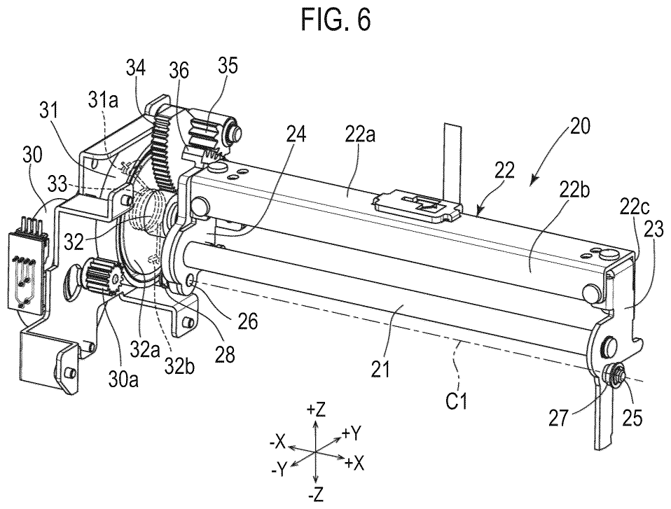

The processing-unit driving mechanism 20 illustrated in FIGS. 5 and 6 supports the processing unit that processes the workpiece medium S, and can perform the first operation of moving the processing unit in the X-axis direction along the workpiece medium S, and the second operation of changing the height position of the processing unit from the sheet surface S1 of the workpiece medium S (an interval in the Z-axis direction with respect to the sheet surface S1). The processing-unit driving mechanism 20 includes a driving belt 46, a pulley 47, a pulley 48, a belt driving motor 49, and the like, which will be described later, in addition to the configuration illustrated in FIGS. 5 and 6. The processing-unit driving mechanism 20 includes a guide member 21 that is a columnar shaft member extending in the X-axis direction, a transmission member 22 that is an elongated member extending in the X-axis direction, and a pair of connection plates 23 and 24 that are connecting members connecting ends on both sides of the guide member 21 and the transmission member 22. Ends on the +X direction side of the guide member 21 and the transmission member 22 are fixed to the connection plate 23, and ends on the −X direction side of the guide member 21 and the transmission member 22 are fixed to the connection plate 24.

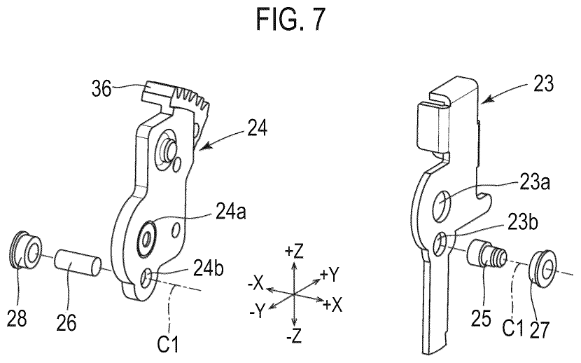

As illustrated in FIG. 7, the connection plate 23 has a connection hole 23a. The end on the +X direction side of the guide member 21 is inserted into the connection hole 23a in a fixed state. In addition, a shaft support hole 23b located on the −Z direction side of the connection hole 23a is formed in the connection plate 23, and a support shaft 25 is inserted into the shaft support hole 23b in a fixed state. The support shaft 25 protrudes from the connection plate 23 toward the +X direction side, and the protruding portion of the support shaft 25 has a cylindrical outer peripheral surface.

The connection plate 24 has a connection hole 24a. An end on the −X direction side of the guide member 21 is inserted into the connection hole 24a in a fixed state. In addition, a shaft support hole 24b located on the −Z direction side of the connection hole 24a is formed in the connection plate 24, and a support shaft 26 is inserted into the shaft support hole 24b in a fixed state. The support shaft 26 protrudes from the connection plate 24 toward the −X direction side, and the protruding portion of the support shaft 26 has a cylindrical outer peripheral surface.

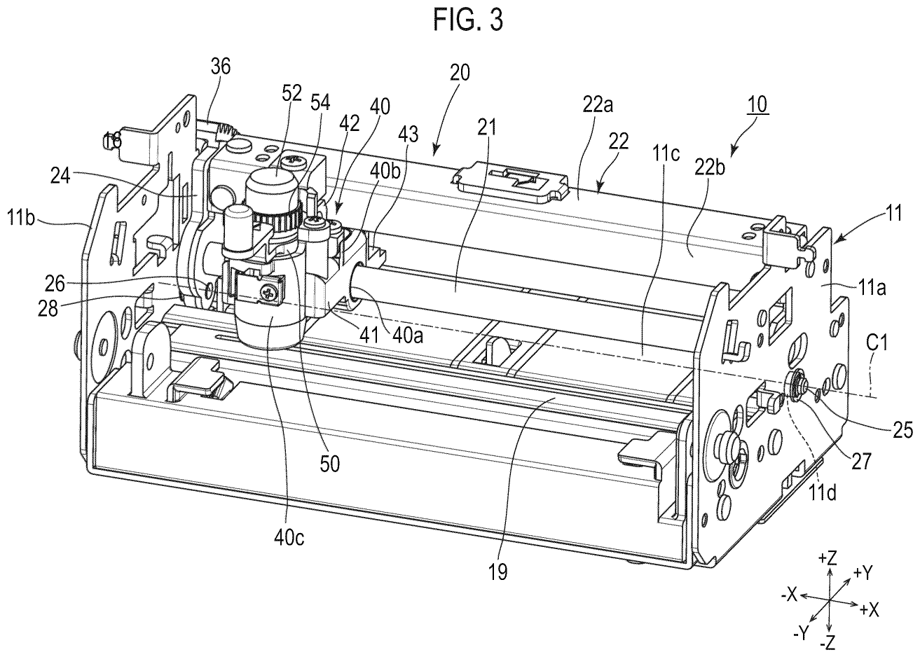

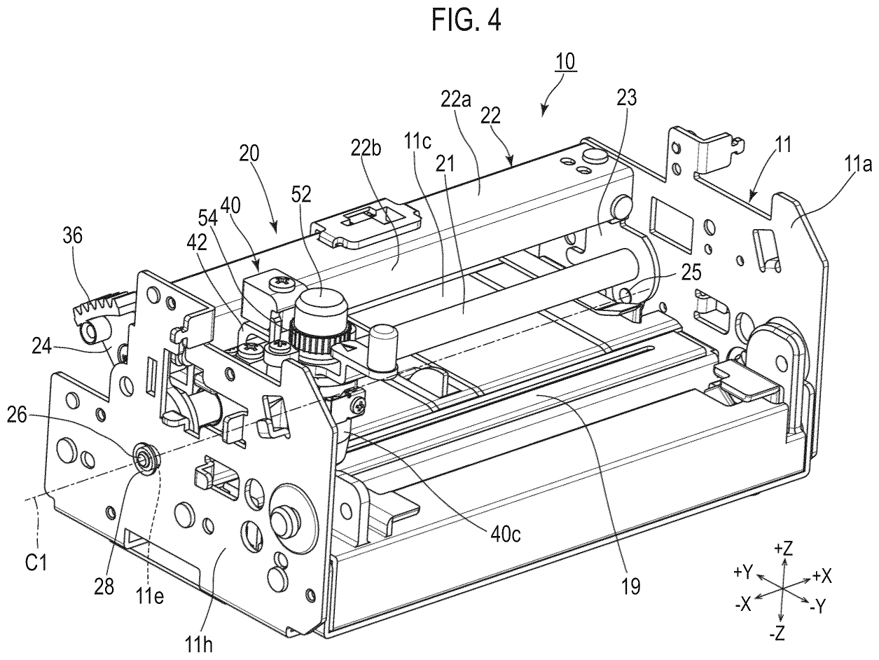

A circular shaft hole 11d (see FIG. 3) penetrating in the X-axis direction is formed in the side plate 11a on the +X direction side of the main body 11. A circular shaft hole 11e (see FIG. 4) penetrating in the X-axis direction is formed in the side plate 11b on the −X direction side of the main body 11. The center of shaft hole 11d and the center of shaft hole 11e are coaxially disposed on virtual shaft center C1 extending in the X-axis direction, a bearing 27 is attached to the shaft hole 11d, and a bearing 28 is attached to the shaft hole 11e. Each of the bearing 27 and the bearing 28 is formed of an annular bearing. The support shaft 25 protruding from the connection plate 23 is inserted into the bearing 27 and rotatably supported about the shaft center C1. The support shaft 26 protruding from the connection plate 24 is inserted into the bearing 28 and rotatably supported about the shaft center C1. That is, the support shaft 25 and the support shaft 26 arranged by being distributed one by one on both sides in the X-axis direction are rotatably supported about the shaft center C1 extending in the X-axis direction with respect to the side plate 11a and the side plate 11b of the main body 11. The support shaft 25 and the support shaft 26 are arranged at positions closer to the workpiece medium S (in other words, the tray 12) than the guide member 21 in the Z-axis direction (−Z direction side of the guide member 21).

As described above, the rotary operation unit including the guide member 21, the transmission member 22, the connection plate 23, and the connection plate 24 is supported rotatably about the shaft center C1 via the bearings 27 and 28 and the support shafts 25 and 26 provided on the connection plates 23 and 24. In other words, the guide member 21 and the transmission member 22 rotate together via the connection plate 23 and the connection plate 24 pivotally supported at the position of the shaft center C1 with respect to the main body 11.

A lifting drive motor 30, which is a drive unit for changing the height position of the processing unit with respect to the sheet surface S1 of the workpiece medium S, is attached to the side portion of the side plate 11b. A pinion 30a is provided on an output shaft of the lifting drive motor 30, and the pinion 30a meshes with a first gear 31.

As illustrated in FIG. 6, the transmission portion 32a of the second gear 32 is supported inside the first gear 31. One end and the other end of a torsion spring 33 are engaged with a spring hooking portion 31a provided inside the first gear 31 and a spring hooking portion 32b provided on the transmission portion 32a of the second gear 32. When the first gear 31 rotates, the deflection amount of the torsion spring 33 increases, and when the torsion spring 33 reaches a predetermined deflection amount, the rotation is transmitted from the first gear 31 to the second gear 32 via the torsion spring 33. That is, in the state where the rotation is transmitted from the first gear 31 to the second gear 32, the spring force of the torsion spring 33 is charged.

The second gear 32 meshes with a fan-shaped first sector gear 34. The first sector gear 34 is provided with a fan-shaped second sector gear 35 that rotates integrally coaxially with the first sector gear 34. The second sector gear 35 meshes with a fan-shaped third sector gear 36 fixed to the connection plate 24. The rotation of the second gear 32 is transmitted to the first sector gear 34, and the second sector gear 35 rotates together with the first sector gear 34. The rotation of the second sector gear 35 is transmitted to the third sector gear 36. When the third sector gear 36 rotates, the guide member 21, the transmission member 22, the connection plate 23, and the connection plate 24 integrally rotate about the shaft center C1.

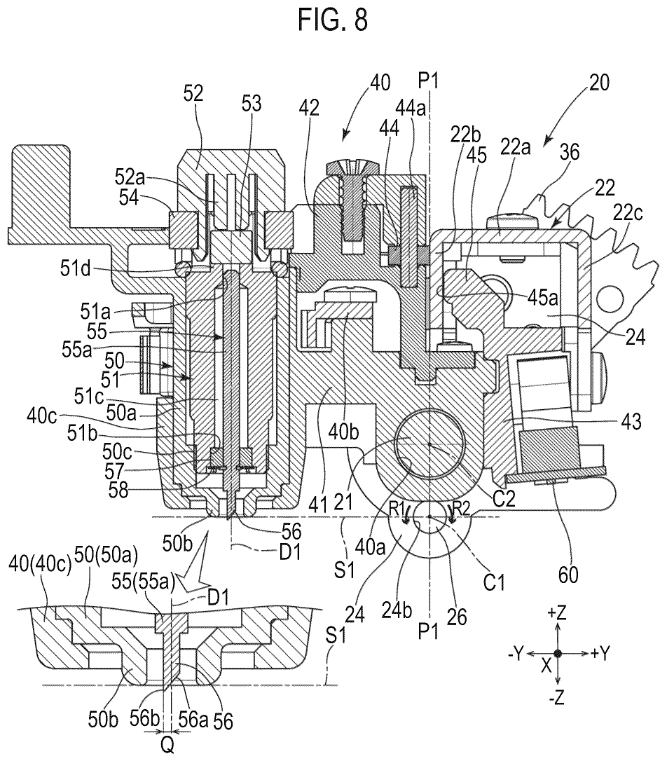

When the lifting drive motor 30 is driven in this manner, the force is transmitted by the gears 31, 32, 34, 35, and 36, and the rotary operation unit including the guide member 21, the transmission member 22, the connection plate 23, and the connection plate 24 rotates about the shaft center C1. By controlling the lifting drive motor 30 to switch the rotation direction of the pinion 30a, the rotation directions of the guide member 21, the transmission member 22, the connection plate 23, and the connection plate 24 can be switched between a first rotation direction R1 and a second rotation direction R2 (see FIGS. 8 to 10). Each of the first gear 31, the second gear 32, the first sector gear 34, and the second sector gear 35 is supported by the side plate 11b so as to be rotatable about a gear shaft extending in the X-axis direction. A pressing load of the processing unit with respect to the workpiece medium S is set according to the force of the torsion spring 33 provided between the first gear 31 and the second gear 32.

A carriage 40, which is a support portion that supports the processing unit, is supported via the guide member 21 and the transmission member 22 extending in the X-axis direction. As illustrated in FIG. 8, the carriage 40 has a guided hole 40a penetrating in the X-axis direction, and the guide member 21 is inserted into the guided hole 40a. An axial center of the guide member 21 extending in the X-axis direction is defined as a shaft center C2. The guided hole 40a has a cylindrical inner peripheral surface, and the carriage 40 is supported so as to be movable in the X-axis direction as the inner peripheral surface of the guided hole 40a comes into sliding contact with the outer peripheral surface of the guide member 21. In addition, the force rotating about the shaft center C1 is transmitted from the transmission member 22 to the carriage 40, and the carriage 40 rotates about the shaft center C1 together with the guide member 21 and the transmission member 22. The movement of the carriage 40 in the X-axis direction along the guide member 21 is defined as the first operation, and the rotation of the carriage 40 about the shaft center C1 is defined as the second operation. The second operation is set as an operation of integrally changing the height position of the processing unit (knife 56 to be described later) from the sheet surface S1 with the guide member 21 and the carriage 40 along with the rotation of the support shaft 25 and the support shaft 26 about the shaft center C1.

The transmission member 22 is a U-shaped cross-sectional member having an upper plate portion 22a, a front plate portion 22b, and a rear plate portion 22c each of which is a flat plate-shaped wall portion. The front plate portion 22b extends downward from the edge on the −Y direction side of the upper plate portion 22a, and the rear plate portion 22c extends downward from the edge on the +Y direction side of the upper plate portion 22a.

The carriage 40 includes a main body portion 41 having a guided hole 40a, and a first transmission portion 42 and a second transmission portion 43 fixed to the main body portion 41. The first transmission portion 42 is disposed on the +Z direction side of the main body portion 41, and the second transmission portion 43 is disposed on the +Y direction side of the main body portion 41. The first transmission portion 42 is provided with a bearing 44. The bearing 44 is rotatably supported via a support shaft 44a provided in the first transmission portion 42, and has a cylindrical outer peripheral surface centered on the support shaft 44a. The support shaft 44a is substantially perpendicular to the X-axis direction and extends substantially parallel to the front plate portion 22b of the transmission member 22. The surface on the +Y direction side of the first transmission portion 42 faces the surface on the −Y direction side of the front plate portion 22b of the transmission member 22. The bearing 44 is disposed so as to be exposed on the surface on the +Y direction side of the first transmission portion 42, and is a contact portion that contacts the surface on the −Y direction side of the front plate portion 22b of the transmission member 22.

The second transmission portion 43 includes a protrusion 45 that protrudes toward the +Z direction side. The protrusion 45 enters the inside of the U-shaped transmission member 22. A contact surface 45a which is a surface on the −Y direction side of the protrusion 45 comes into contact with a surface on the +Y direction side of the front plate portion 22b of the transmission member 22. The bearing 44 and the contact surface 45a are in contact with the front plate portion 22b so as to be relatively movable in the X-axis direction. In addition, when the transmission member 22 performs the second operation that is the rotation about the shaft center C1, the force is transmitted from the front plate portion 22b to the bearing 44 and the contact surface 45a, and the carriage 40 rotates about the shaft center C1 together with the transmission member 22. More specifically, when the bearing 44 is pressed by the front plate portion 22b of the transmission member 22, the carriage 40 rotates in the first rotation direction R1, and when the protrusion 45 (contact surface 45a) of the second transmission portion 43 is pressed by the front plate portion 22b of the transmission member 22, the carriage 40 rotates in the second rotation direction R2.

The main body portion 41 of the carriage 40 is provided with a belt connection portion 40b. The driving belt 46 is connected to the belt connection portion 40b. The driving belt 46 is an endless belt stretched between the pulley 47 supported by the side plate 11a and the pulley 48 supported by the side plate 11b, and has a loop structure in which the driving belt 46 turns between the pulley 47 and the pulley 48. The pulley 47 is rotated by the driving force generated by the belt driving motor 49 attached to the side portion of the side plate 11a. When the pulley 47 is rotated by the driving of the belt driving motor 49, the driving belt 46 moves in the X-axis direction to transmit the force to the belt connection portion 40b, thereby moving the carriage 40 in the X-axis direction. The moving direction of the carriage 40 in the X-axis direction can be switched by controlling the belt driving motor 49 to switch the rotation direction of the pulley 47.

As described above, in the processing-unit driving mechanism 20, the carriage 40 can be caused to rotate about the shaft center C1 (the second operation) by the driving of the lifting drive motor 30. Further, the movement (first operation) of the carriage 40 in the X-axis direction can be performed by driving the belt driving motor 49.

A holder attaching/detaching portion 40c for detachably holding the processing unit holder 50 is provided at a portion on the −Y direction side of the main body portion 41 of the carriage 40. The processing unit holder 50 is snap-fit fixed by being rotated in a state of being inserted into the holder attaching/detaching portion 40c. The processing unit holder 50 includes a cylindrical holding tube 50a. An annular protrusion 50b is formed at an end on the −Z direction side of the holding tube 50a. The holding tube 50a has a through hole communicating from the upper end to the annular protrusion 50b on the lower end side, and a female screw 50c is formed on a part of the inner peripheral surface of the through hole. Various processing units for processing the workpiece medium S can be attached to the processing unit holder 50. The present embodiment illustrates a case where a knife 56, which is a cutting tool for cutting the workpiece medium S, is attached as the processing unit. The knife 56 is attached to the processing unit holder 50 via a knife holder 51.

The knife holder 51 has a substantially cylindrical shape that can be inserted into the cylindrical holding tube 50a of the processing unit holder 50. A part of the outer peripheral surface of the knife holder 51 near the lower end to be inserted into the cylindrical holding tube 50a is provided with a male screw to be screwed into the female screw 50c of the cylindrical holding tube 50a. A housing hole extending in the axial direction of the knife holder 51 is formed inside the knife holder 51. A shaft holding hole 51a is provided at an end on the +Z direction side of the housing hole, a bearing holding hole 51b is provided at an end on the −Z direction side of the housing hole, and a hollow portion 51c is provided between the shaft holding hole 51a and the bearing holding hole 51b. A cylindrical support projection 51d communicating with the shaft holding hole 51a is provided at an end on the +Z direction side of the knife holder 51. Each of the shaft holding hole 51a, the bearing holding hole 51b, and the hollow portion 51c has a cylindrical inner peripheral surface, and the centers thereof are arranged coaxially.

A cap 52 is attached to the end of the +Z direction side of the knife holder 51. A magnet 53 is supported at a position in the Z-axis direction sandwiched between the support projection 51d provided on the knife holder 51 and the support projection 52a provided inside the cap 52. By attaching the cap 52 to the knife holder 51, the magnet 53 is arranged in the vicinity of the shaft holding hole 51a. An annular grip portion 54 is provided on an outer peripheral portion of the cap 52. When the user grips the grip portion 54 and rotates the cap 52 and the knife holder 51, the knife holder 51 and the cap 52 can be attached to and detached from the processing unit holder 50.

A knife unit 55 is inserted into the housing hole of the knife holder 51. The knife unit 55 has a rod-shaped shaft portion 55a, and a knife 56 as a cutting tool is fixed to an end portion of the shaft portion 55a on the −Z direction side. In a narrow sense, the knife 56 constitutes a processing unit in the medium processing device 10, and in a broad sense, the entire knife unit 55 including the knife 56 and the knife holder 51 supporting the knife unit 55 are included in the processing unit.

An annular knife bearing 57 is attached inside the bearing holding hole 51b of the knife holder 51. The knife bearing 57 is restricted from being detached from the bearing holding hole 51b toward the −Z direction side by a snap ring 58. The knife unit 55 is supported via the knife bearing 57 so as to be rotatable about a blade axis D1 passing through the center of the shaft portion 55a.

In a state where the knife unit 55 is inserted into the housing hole of the knife holder 51, an end portion of the shaft portion 55a on the +Z direction side is inserted into the shaft holding hole 51a and is located in the vicinity of the magnet 53 supported by the support projection 51d. At least the shaft portion 55a of the knife unit 55 is made of a magnetic material, is attracted toward the +Z direction side by the magnetic force of the magnet 53, resulting in keeping the state in which the knife unit 55 is inserted into the housing hole of the knife holder 51.

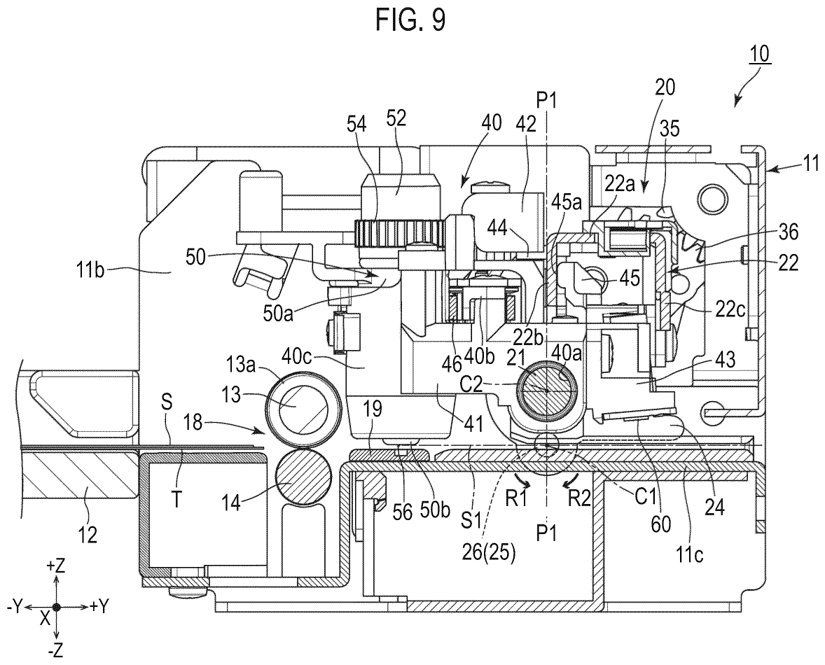

With the cap 52, the magnet 53, and the knife unit 55 attached to the knife holder 51, the knife 56 protrudes from the knife holder 51 toward the −Z direction side. When the knife holder 51 in this state is attached to the processing unit holder 50, as illustrated in an enlarged view in FIG. 8, the screwing amount of the male screw of the knife holder 51 with respect to the female screw 50c of the holding tube 50a is adjusted such that the tip of the knife 56 slightly protrudes in the −Z direction side from the tip of the annular protrusion 50b of the processing unit holder 50. For example, in a state where the carriage 40 is at a processing position (FIG. 9) to be described later, the protrusion amount of the knife 56 is set such that the knife 56 penetrates the workpiece medium S in the Z-axis direction and does not penetrate the mount T.

In a state where the knife unit 55 is held by the knife holder 51, the blade axis D1 of the shaft portion 55a coincides with the shaft center of the knife holder 51. As illustrated in FIG. 8, the knife 56 has a ridge-shaped blade edge surface 56a inclined with respect to the blade axis D1, and the blade axis D1 passes through an intermediate position of the blade edge surface 56a. Therefore, a distal end portion 56b located on the most −Z direction side of the knife 56 is located at a position shifted from the blade axis D1 in the direction perpendicular to the blade axis D1. A shift amount of the distal end portion 56b of the knife 56 with respect to the blade axis D1 is defined as an offset amount Q. A position detection sensor 60 is provided on a lower surface of the carriage 40. The position detection sensor 60 is a non-contact sensor that optically detects an alignment mark (registration mark) provided on the mount T or the workpiece medium S.

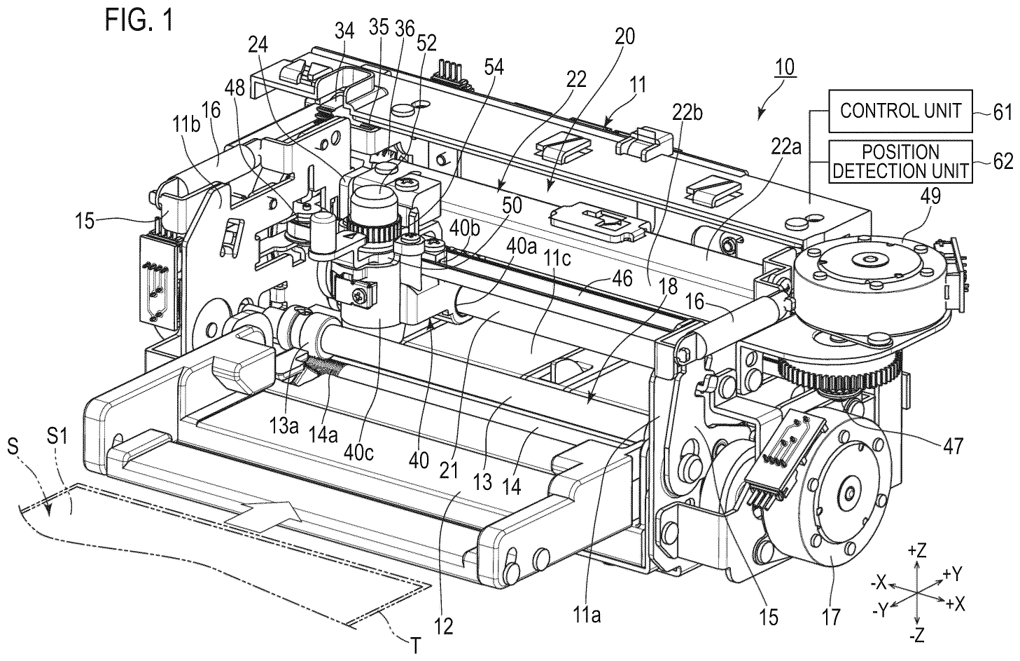

The medium processing device 10 includes a control unit 61 (see FIG. 1). The control unit 61 includes a processor such as a central processing unit (CPU) and a storage unit, and controls the operation of each unit of the medium processing device 10 by reading a program stored in the storage unit and executing the program by the processor. The control unit 61 controls at least operations of the roller driving motor 17, the lifting drive motor 30, and the belt driving motor 49. A detection signal of the position detection sensor 60 is input to the control unit 61.

The medium processing device 10 includes a position detection unit 62 that detects a rotational position of the transmission member 22 and the carriage 40 about the shaft center C1 (see FIG. 1). For example, the position detection unit 62 includes an optical sensor such as a photointerrupter, and the detection is performed at the moment when a part of the transmission member 22 or the carriage 40 passes between a light projecting unit and a light receiving unit of the photointerrupter and the light is blocked. A detection signal of the position detection unit 62 is input to the control unit 61.

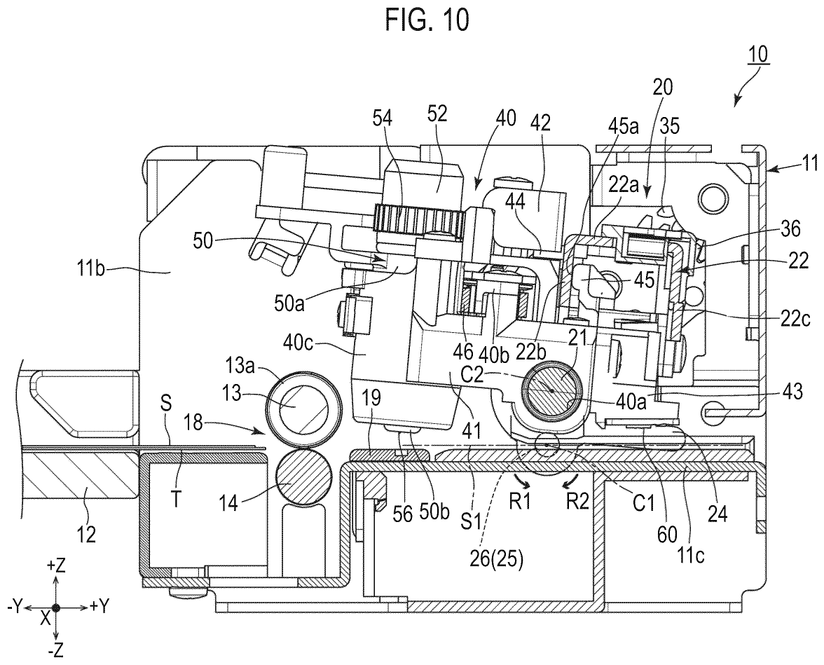

The position detection unit 62 detects the retracted position (FIG. 10) of the transmission member 22 and the carriage 40. The retracted position is a height position at which the knife 56 supported via the carriage 40, the processing unit holder 50, and the knife holder 51 is retracted upward from the sheet surface S1 of the workpiece medium S without cutting into the workpiece medium S supported in the medium supporting region of the medium processing device 10. In the retracted position, the transmission member 22 and the carriage 40 are rotated in the second rotation direction R2, the transmission member 22 is inclined so as to lower the rear plate portion 22c side toward the −Z direction side, and along with the inclination of the transmission member 22, the processing unit holder 50 and the knife holder 51 located on the −Y direction side with respect to the support shaft 25 and the support shaft 26 (shaft center C1), which are the rotation center of the transmission member 22, are inclined in a direction (+Z direction side) of expanding the interval with the workpiece medium S in the Z-axis direction.

The control unit 61 detects the processing positions (FIG. 9) of the transmission member 22 and the carriage 40 based on the drive amount of the lifting drive motor 30 when the transmission member 22 and the carriage 40 are rotated in the first rotation direction R1 with the retracted position detected by the position detection unit 62 as a reference. For example, the lifting drive motor 30 is a pulse motor, and the control unit 61 detects the rotation amount of the transmission member 22 and the carriage 40 in the first rotation direction R1 and the arrival at the processing position by counting the number of drive pulses of the lifting drive motor 30 that rotates in the first rotation direction R1 from the retracted position. The processing position is a height position at which the knife 56 supported via the carriage 40, the processing unit holder 50, and the knife holder 51 is pressed against the workpiece medium S supported in the medium supporting region of the medium processing device 10 to cut (process) the workpiece medium S. At the processing position, the upper plate portion 22a of the transmission member 22 is substantially horizontal (substantially vertical to the Z-axis direction), the front plate portion 22b and the rear plate portion 22c are substantially vertical (substantially vertical to the Y-axis direction), and the blade axis D1 of the knife unit 55 is parallel to the Z-axis direction.

As described above, in the second operation performed by the processing-unit driving mechanism 20, the guide member 21, the transmission member 22, the connection plate 23, and the connection plate 24 are rotated in the first rotation direction R1 about the shaft center C1, so that the carriage 40 moves toward the processing position. The guide member 21, the transmission member 22, the connection plate 23, and the connection plate 24 are rotated in the second rotation direction R2 about the shaft center C1, so that the carriage 40 moves toward the retracted position. In a state where the carriage 40 is located at the processing position (FIG. 9), the shaft center C1 of the support shaft 25 and the support shaft 26 and the shaft center C2 of the guide member 21 are aligned with each other in the Y-axis direction, and the shaft center C1 and the shaft center C2 are located on a virtual plane P1 oriented in the Z-axis direction.

The operation of the medium processing device 10 having the above configuration will be described. When attaching the workpiece medium S to the medium processing device 10, the control unit 61 controls the lifting drive motor 30 to position the transmission member 22 and the carriage 40 at the retracted position (FIG. 10). Subsequently, when the workpiece medium S is placed on the tray 12 and the workpiece medium S is inserted between the conveying roller 13 and the conveying roller 14, an intrusion detection sensor (not illustrated) detects the intrusion of the workpiece medium S, and the conveying roller 14 starts to rotate. Thus, the workpiece medium S is sandwiched between the pinching portion 13a of the conveying roller 13 and the pinching portion 14a of the conveying roller 14.

The control unit 61 drives the roller driving motor 17 to feed the workpiece medium S in the Y-axis direction, drives the belt driving motor 49 to adjust the position of the carriage 40 in the X-axis direction, and detects the alignment mark of the workpiece medium S by the position detection sensor 60. The workpiece medium S is supported below the carriage 40 while being placed on the upper surface of the support plate 19. In this state, preparation for cutting of the workpiece medium S by the medium processing device 10 is completed.

Cutting data for cutting the workpiece medium S is input to the control unit 61, and cutting processing is executed based on the cutting data. By driving the belt driving motor 49 to move the carriage 40 in the X-axis direction and driving the roller driving motor 17 to move the workpiece medium S in the Y-axis direction, the workpiece medium S and the knife 56 can be relatively moved in the horizontal direction along the trajectory along the cutting line. Then, in the cutting target region, the control unit 61 drives the lifting drive motor 30 and rotates the transmission member 22 and the carriage 40 in the first rotation direction R1 to move the transmission member 22 and the carriage 40 from the retracted position to the processing position. As a result, the knife 56 descends and approaches the workpiece medium S, and the knife 56 pressed against the sheet surface S1 cuts into the workpiece medium S to execute cutting.

The knife unit 55 is supported so as to be rotatable about the blade axis D1 with respect to the knife holder 51. Therefore, the knife 56 cut into the workpiece medium S is angularly adjusted around the blade axis D1 so that the direction of the blade edge surface 56a always follows the advancing direction of cutting by a cutting load, frictional force, or the like acting between the knife 56 and the workpiece medium S, and cutting can be executed smoothly. More specifically, there is a distance of an offset amount Q (FIG. 8) in the horizontal direction from the blade axis D1 which is the rotation center of the knife unit 55 to the distal end portion 56b of the knife 56 cut into the workpiece medium S. As a result, when the workpiece medium S and the knife 56 are relatively moved in the horizontal direction, in a case where the direction of the virtual line segment connecting the blade axis D1 and the distal end portion 56b does not coincide with the relative movement direction of the knife 56 with respect to the workpiece medium S, a force that causes these directions to coincide with each other acts on the knife 56 from the workpiece medium S, and the knife unit 55 rotates about the blade axis D1 with respect to the knife holder 51. As a result, during cutting of the workpiece medium S by the knife 56, the rotational position of the knife unit 55 about the blade axis D1 is automatically changed such that the direction of the blade edge surface 56a of the knife 56 follows the traveling direction in which the knife 56 moves with respect to the workpiece medium S, and the distal end portion 56b is located on the rear side in the traveling direction.

Since the knife unit 55 is attracted by the magnetic force of the magnet 53 and is supported by the knife holder 51 via the knife bearing 57, the rotational resistance with respect to the knife unit 55 is extremely small, and the followability of the direction of the blade edge surface 56a of the knife 56 with respect to the change in the progressing direction of cutting is excellent. In the region not targeted for cutting, the control unit 61 drives the lifting drive motor 30 and rotates the transmission member 22 and the carriage 40 in the second rotation direction R2 to move the transmission member 22 and the carriage 40 from the processing position to the retracted position. As a result, the knife 56 moves in the +Z direction to be separated from the workpiece medium S, and the knife 56 is not cut into the workpiece medium S.

When the series of cutting operations based on the cutting data is completed, the control unit 61 drives the lifting drive motor 30 to rotate the transmission member 22 and the carriage 40 in the second rotation direction R2 and hold them at the retracted position.

Subsequently, the control unit 61 rotates the conveying roller 14 to move the mount T and the workpiece medium S to the −Y direction side, and stops the conveying roller 14 when the intrusion detection sensor detects that the mount T is separated from between the pinching portion 13a and the pinching portion 14a.

As described above, in the processing-unit driving mechanism 20 of the medium processing device 10, the first operation of moving the carriage 40 together with the knife 56 in the first direction (X-axis direction) and the second operation of rotating the carriage 40 together with the knife 56 about the axis (shaft center C1) along the first direction (X-axis direction) to change the height position of the knife 56 with respect to the workpiece medium S can be executed.

Since the second operation is performed by the rotation of the carriage 40 about the shaft center C1 extending in the first direction (X-axis direction) in which the carriage 40 is moved in the first operation, the first operation and the second operation can be realized by a simple and small structure. For example, as compared with a configuration including a first stage linearly moving in the X-axis direction and a second stage linearly moving in the Z-axis direction with respect to the first stage, in which the processing unit is supported in the second stage, the structure of the processing-unit driving mechanism 20 for performing the second operation is reduced in size and weight, and the responsiveness and accuracy of the operation when performing the first operation and the second operation are improved.

In addition, since the rotation is transmitted to the carriage 40 via the transmission member 22, the support shaft 25 and the support shaft 26 that support the rotation about the shaft center C1 can be set to have a simple cylindrical shape without a complicated shape for rotation transmission.

The transmission member 22 having a U-shaped cross section including the upper plate portion 22a, the front plate portion 22b, and the rear plate portion 22c has high rigidity while being a long member extending in the X-axis direction. Further, both ends of the guide member 21 and the transmission member 22 are fixed by the pair of connection plates 23 and 24, and the rotary operation unit in which the guide member 21, the transmission member 22, the connection plate 23, and the connection plate 24 are combined has high rigidity. The connection plate 23 and the connection plate 24 constituting the rotary operation unit having high rigidity are provided with the support shaft 25 and the support shaft 26 which are the rotation center of the second operation, and the support shaft 25 and the support shaft 26 are supported by the bearing 27 and the bearing 28 provided in the side plates 11a and 11b of the main body 11 having high rigidity. As a result, when the lifting drive motor 30 is driven, twisting of the rotary operation unit, rattling of the shaft support portion via the support shaft 25 and the support shaft 26, and the like are suppressed, and the carriage 40 can be stably rotated while being supported with high accuracy.

As described above, the second operation of changing the height position of the knife 56 in the Z-axis direction is performed as rotation about the shaft center C1 passing through the center between the support shaft 25 and the support shaft 26. In the medium processing device 10 of the present embodiment, as illustrated in FIG. 8, the height position of the shaft center C1 in the Z-axis direction is set at substantially the same position as the height position of the sheet surface S1 of the workpiece medium S in the Z-axis direction. In other words, in the height direction (Z-axis direction) perpendicular to the sheet surface S1, the height positions of the shaft center C1 of the support shaft 25 and the support shaft 26 are substantially the same as the height position of the blade edge surface 56a when the knife 56 positioned at the processing position cuts the workpiece medium S (see FIG. 9). The configuration in which the height position of the shaft center C1 is substantially the same as the height position of the sheet surface S1 and the height position of the blade edge surface 56a includes a case where the height positions are completely the same and a case where the height positions are slightly different. For example, even in a case where the height positions are the same in design and the height positions are slightly different from each other due to an accuracy error within an allowable range in an actual product, the requirements that the height positions are substantially the same are satisfied.

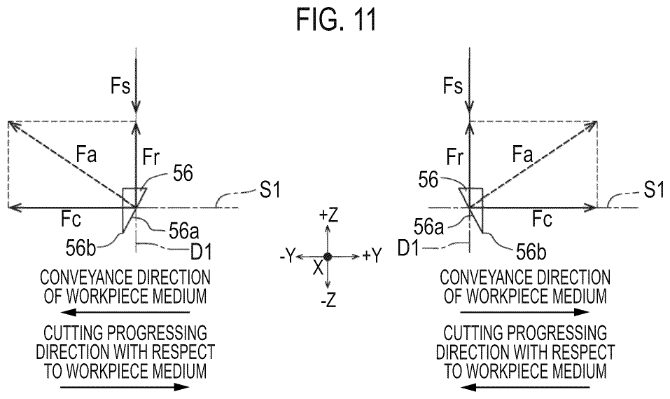

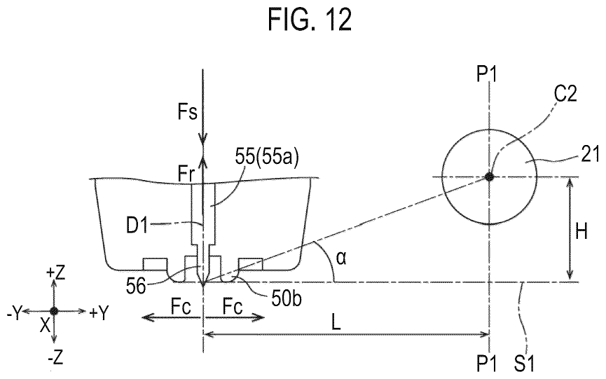

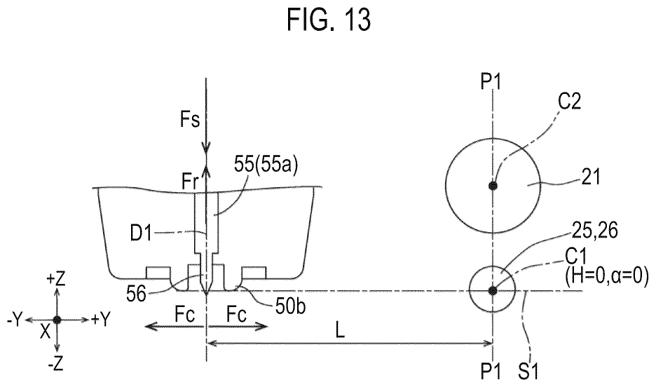

The setting of the height position of the shaft center C1 will be described with reference to conceptual diagrams illustrated in FIG. 11 and subsequent drawings. Note that, in order to eliminate the influence of load variation due to the offset of the distal end portion 56b of the knife 56 with respect to the blade axis D1 described later, in FIGS. 12 and 13, the shape of the knife 56 is assumed such that the distal end portion of the blade is located on the blade axis D1 and has a blade edge surface symmetrical on the +Y direction side and the −Y direction side with respect to the blade axis D1.

When cutting is performed by pressing the knife 56 against the workpiece medium S and moving the workpiece medium S in the Y-axis direction (second direction), a load as illustrated in FIG. 11 acts. The overall load acting on the knife 56 at the time of cutting is a cutting full load Fa, the vertical component force of the cutting full load Fa is a cutting pressing reaction force Fr, and the horizontal component force of the cutting full load Fa is the cutting load Fc. The cutting pressing reaction force Fr and the cutting load Fc are determined according to conditions such as the material and thickness of the workpiece medium S and the shape of the knife 56. In the following description, it is assumed that conditions regarding the material and thickness of the workpiece medium S are constant.

The cutting pressing reaction force Fr is a reaction force that causes the knife 56 to rise toward the +Z direction side when cutting the workpiece medium S. The cutting pressing reaction force Fr changes according to the angle of the blade edge surface 56a of the knife 56 with respect to the sheet surface S1, and the cutting pressing reaction force Fr increases as the inclination of the blade edge surface 56a approaches the horizontal direction (direction parallel to the sheet surface S1). When the carriage 40 is located at the processing position (FIG. 9), the torsion spring 33 disposed in the path through which the driving force of the lifting drive motor 30 is transmitted in the processing-unit driving mechanism 20 presses the carriage 40 toward the −Z direction side with the pressing spring load Fs larger than the cutting pressing reaction force Fr, thereby preventing the knife 56 from rising.

The cutting load Fc is a load (resistance) that acts horizontally on the knife 56 at the height position of the sheet surface S1 when the workpiece medium S is moved in the Y-axis direction and cut. In a case where the processing is advanced toward the +Y direction side (third direction) with respect to the workpiece medium S (in a case where the workpiece medium S is conveyed toward the −Y direction side and cut), the blade edge surface 56a faces the +Y direction side by the rotation of the knife unit 55 around the blade axis D1, and the cutting load Fc acts on the knife 56 toward the −Y direction side. In a case where the processing is advanced toward the −Y direction side (fourth direction) with respect to the workpiece medium S (in a case where the workpiece medium S is conveyed toward the +Y direction side and cut), the blade edge surface 56a faces the −Y direction side by the rotation of the knife unit 55 around the blade axis D1, and the cutting load Fc acts on the knife 56 toward the +Y direction side.

When the workpiece medium S is cut by the knife 56, if the load applied to the knife 56 greatly varies depending on the difference in the cutting progressing direction, the cutting accuracy may vary. For example, when the load variation on the knife 56 is large, the workpiece medium S can be insufficiently cut in a specific cutting direction, resulting in a cutting failure. In the comparative example illustrated in FIG. 12, the rotation center of the second operation of changing the height position of the knife 56 with respect to the sheet surface S1 is set at a position farther from the sheet surface S1 than the shaft center C1 which is the rotation center of the second operation in the above embodiment. More specifically, the shaft center C2 of the guide member 21, which is a shaft member extending in the X-axis direction, is set as the rotation center of the second operation. Then, the carriage 40 is configured to rotate about the shaft center C2 together with the transmission member 22. A distance in the horizontal direction (Y-axis direction) from the shaft center C2, which is the rotation center of the carriage 40, to the blade axis D1 of the knife unit 55 is defined as L. A distance in the height direction (Z-axis direction) from the sheet surface S1 to the shaft center C2 is defined as H. An angle formed by an imaginary line connecting a point at which the blade axis D1 intersects the sheet surface S1 and the shaft center C2 with respect to the sheet surface S1 is α. In the case of α≠0, when the cutting load Fc in the Y-axis direction acts on the knife 56 at the height position of the sheet surface S1, a component force for rotating the carriage 40 about the shaft center C2 is generated.

For example, when the cutting load Fc acts on the +Y direction side at the height position of the sheet surface S1, a force in a direction of causing the knife 56 to cut into the workpiece medium S acts on the carriage 40 rotatable about the shaft center C2 located on the +Z direction side with respect to the sheet surface S1. When the cutting load Fc acts on the −Y direction side at the height position of the sheet surface S1, a force in a direction of releasing (keeping away) the knife 56 from the workpiece medium S acts on the carriage 40 rotatable about the shaft center C2 located on the +Z direction side with respect to the sheet surface S1. As described above, when the height position of the shaft center C2 is deviated from the height position of the sheet surface S1, the pressing load of the knife 56 with respect to the workpiece medium S varies according to the difference in the direction in which the cutting load Fc acts (the difference in the conveyance direction of the workpiece medium S at the time of cutting).

The relationship between the distance H in the height direction from the sheet surface S1 to the shaft center C2 and the distance L in the horizontal direction from the shaft center C2 to the blade axis D1 is set as k=H/L. Due to the influence of the load variation, the total pressing load F acting on the knife 56 at the time of cutting is F=Fs+Fc×k when the cutting load Fc acts on the +Y direction side, and F=Fs−Fc×k when the cutting load Fc acts on the −Y direction side.

Therefore, regarding the position setting of the shaft center which is the rotation center of the second operation of the carriage 40, in a case where the distance L in the horizontal direction from the blade axis D1 to the shaft center is constant, as the distance H in the height direction from the sheet surface S1 to the shaft center decreases (as the angle α decreases), the force in a direction of causing the knife 56 to cut into the workpiece medium S decreases when the cutting load Fc acts on the +Y direction side, and the force in a direction of releasing the knife 56 from the workpiece medium S decreases when the cutting load Fc acts on the −Y direction side. As a result, when the distance H in the height direction from the sheet surface S1 to the shaft center is reduced, the difference between the total pressing load F when the workpiece medium S is cut toward the +Y direction side and the total pressing load F when the workpiece medium S is cut toward the −Y direction side is reduced. From such a technical viewpoint, in the present disclosure, with respect to the member arrangement in the height direction (Z-axis direction) perpendicular to the sheet surface S1, at least the support shaft 25 and the support shaft 26, which are portions to be the rotation center of the second operation in the processing-unit driving mechanism 20, are arranged on the side closer to the sheet surface S1 of the workpiece medium S than the guide member 21 that guides the first operation.

Furthermore, as in the conceptual diagram of the present embodiment illustrated in FIG. 13, by making the height position of the shaft center C1, which is the rotation center of the second operation of the carriage 40, substantially the same as the height position of the sheet surface S1 (set H=0 and α=0), the load fluctuation described above does not occur between the case where the cutting load Fc acts on the +Y direction side and the case where the cutting load Fc acts on the −Y direction side, and there is substantially no difference between the total pressing load F in the case of cutting the workpiece medium S toward the +Y direction side and the total pressing load F in the case of cutting the workpiece medium S toward the −Y direction side. As a result, a variation in the load on the knife 56 due to the difference in the conveyance direction of the workpiece medium S by the medium conveying mechanism 18 is prevented, and uniform processing quality can be obtained regardless to which conveyance direction (Y-axis direction) cutting is performed.

In a case where the processing unit is a knife that is a cutting tool, since an operation resistance and a reaction force received at the time of cutting are large, load fluctuation based on a difference in a processing direction in the Y-axis direction tends to be large. Therefore, it is particularly useful to apply the position setting of the shaft center of the second motion according to the present disclosure when the processing unit is a knife. However, even when the processing unit performs processing other than cutting, the operation and effect of the present disclosure can be obtained. For example, in a case where the processing unit is a writing implement such as a pen, when the workpiece medium S is conveyed in the Y-axis direction in a state where the writing tool is pressed against the workpiece medium S, movement resistance is applied by a frictional force acting between the workpiece medium S and the writing tool. Since this movement resistance acts as a load similar to the above-described cutting load Fc, by applying the position setting of the shaft center of the second operation according to the present disclosure, the pressing load of the writing implement against the workpiece medium S becomes substantially constant even when the traveling direction of the processing in the Y-axis direction changes to the +Y direction side and the −Y direction side, and excellent processing quality can be obtained.

As described above, from the viewpoint of suppressing the load fluctuation due to the difference in the conveyance direction of the workpiece medium S, the support shafts 25 and 26 having the shaft center C1 which is the rotation center of the second operation may be arranged at least on the side closer to the workpiece medium S than the guide member 21 that guides the carriage 40 so as to be movable in the X-axis direction in the height direction perpendicular to the sheet surface S1. More preferably, as illustrated in FIG. 13, the height position of the shaft center C1, which is the rotation center of the second operation, in the height direction perpendicular to the sheet surface S1 may be substantially the same as the height position of the sheet surface S1. In addition, when the processing unit includes the knife 56 as a cutting tool, the height position of the shaft center C1 of the support shaft 25 and the support shaft 26 may be set to be substantially the same as the height position of the blade edge surface 56a when the knife 56 positioned at the processing position cuts the workpiece medium S.

By arranging the height positions of the support shaft 25 and the support shaft 26 on the side closer to the workpiece medium S than the height position of the guide member 21, the distance from the shaft center C1, which is the rotation center of the second operation of the carriage 40, to the location (bearing 44, protrusion 45) where the transmission member 22 transmits the force in the rotation direction of the second operation to the carriage 40 becomes larger than that in the comparative example of FIG. 12. As a result, when the transmission member 22 presses the carriage 40, the load applied to the transmission member 22 per unit rotation angle of the carriage 40 is reduced, and the second operation can be performed by efficiently using the driving force of the lifting drive motor 30.

In a case where the height position of the rotation center of the second operation is set close to the height position of the sheet surface S1 of the workpiece medium S or in a case where the height position of the rotation center of the second operation is set to be substantially the same as the height position of the sheet surface S1, it is required that the support shaft serving as the rotation center of the second operation is configured not to interfere with the internal structure (the inner plate 11c, the support plate 19, or the like) of the main body 11 that supports the workpiece medium S or the workpiece medium S itself. In the medium processing device 10 of the present embodiment, the support shaft 25 and the support shaft 26 are arranged at positions shifted in the X-axis direction with respect to the medium supporting region where the workpiece medium S is supported. More specifically, one support shaft 25 and one support shaft 26 are arranged by being distributed to both sides (the +X direction side and the −X direction side) in the X-axis direction with the medium supporting region where the workpiece medium S is supported therebetween. As a result, the support shaft 25 and the support shaft 26 can be disposed at a height position close to the sheet surface S1 or at a height position substantially the same as the sheet surface S1 without interfering with the conveyance of the workpiece medium S or interfering with the inner plate 11c or the support plate 19 that supports the workpiece medium S.

The support shaft 25 and the support shaft 26 are provided on the connection plate 23 and the connection plate 24 that connect one end and the other end in the X-axis direction of the guide member 21 and the transmission member 22, respectively. The support shaft 25 is supported by the bearing 27 arranged on the side plate 11a of the main body 11 adjacent on the +X direction side of the connection plate 23, and the support shaft 26 is supported by the bearing 28 arranged on the side plate 11b of the main body 11 adjacent on the −X direction side of the connection plate 24. In addition, the rotary operation unit in which the guide member 21, the transmission member 22, the connection plate 23, and the connection plate 24 are combined has high rigidity, and twisting of the rotary operation unit and positional displacement between the support shaft 25 and the support shaft 26 hardly occur. For these reasons, the support shaft 25 and the support shaft 26 disposed at positions separated in the X-axis direction are supported by the main body 11 having high rigidity to form a strong double-supported support structure, and the second operation that is the rotation of the carriage 40 about the shaft center C1 can be performed with high stability and high accuracy. Further, the support shaft 25 and the support shaft 26 are supported via the bearing 27 and the bearing 28, respectively, and the rotation of the carriage 40 about the shaft center C1 can be smoothly performed with a small resistance.

In addition, the support structure via the support shaft 25 having a short length in the X-axis direction is arranged in a narrow range in the X-axis direction from the connection plate 23 to the side plate 11a, the support structure via the support shaft 26 having a short length in the X-axis direction is arranged in a narrow range in the X-axis direction from the connection plate 24 to the side plate 11b, and the support structure for causing the carriage 40 to perform the second operation is accommodated on both sides of the medium supporting region where the workpiece medium S is supported with high space efficiency.

As illustrated in FIGS. 8 to 10, the support shaft 25, the support shaft 26, and the guide member 21 are disposed at substantially the same position in the Y-axis direction. More specifically, when the carriage 40 is positioned at the processing position, the shaft center C1 of the support shaft 25 and the support shaft 26 and the shaft center C2 of the guide member 21 are disposed at the same position in the Y-axis direction (on the plane P1 oriented in the Z-axis direction) in the side view illustrated in FIGS. 8 and 9. With this configuration, it is possible to prevent the processing-unit driving mechanism 20 from increasing in size in the Y-axis direction. In addition, since the weight balance of the processing-unit driving mechanism 20 in the Y-axis direction is taken about the vicinity of the guide member 21 that guides the first operation of the carriage 40, by arranging the support shaft 25 and the support shaft 26 at positions that do not deviate from the guide member 21 in the Y-axis direction, it is possible to smoothly and efficiently perform the rotary operation (second operation) about the shaft center C1 without losing the weight balance of the processing-unit driving mechanism 20 in the Y-axis direction.

Unlike the conceptual diagram illustrated in FIG. 13, the knife 56 of the present embodiment has a single-edged structure having the blade edge surface 56a only on one side, and as illustrated in FIG. 8, the position of the distal end portion 56b of the knife 56 has a shift (offset amount Q) with respect to the blade axis D1 which is the rotation center of the knife unit 55. Then, as illustrated in FIG. 11, the knife 56 rotates around the blade axis D1 and the position of the distal end portion 56b with respect to the blade axis D1 changes in the Y-axis direction between the case of conveying and cutting the workpiece medium S toward the −Y direction side and the case of conveying and cutting the workpiece medium S toward the +Y direction side.

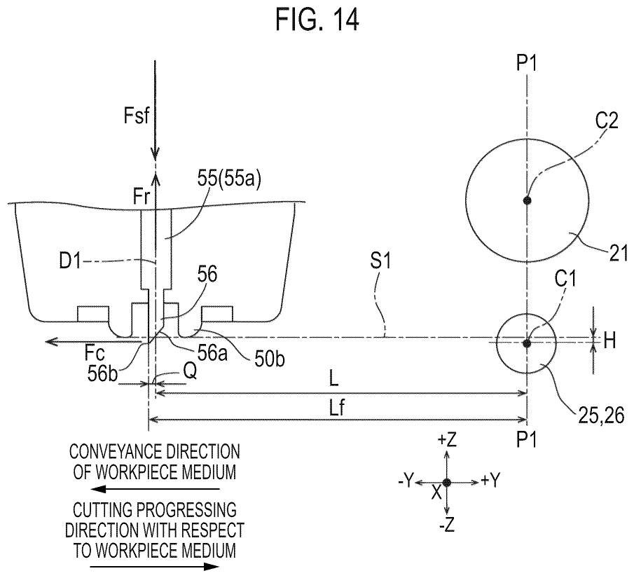

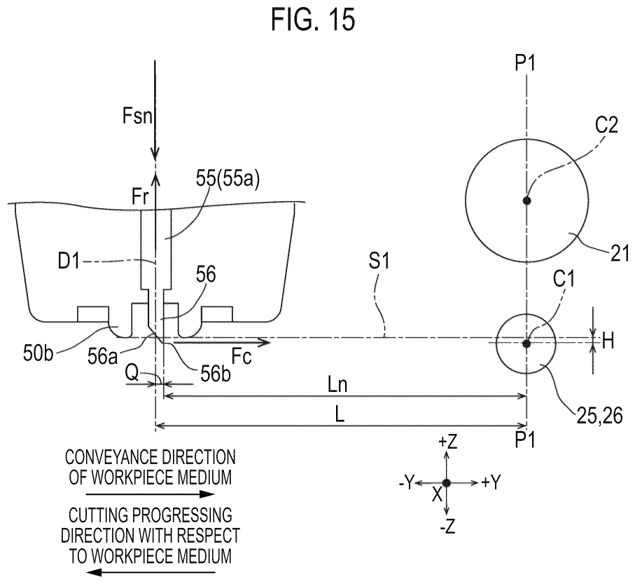

For example, it is assumed that the distance L in the Y-axis direction from the shaft center C1, which is the rotation center of the second operation of the carriage 40, to the blade axis D1 of the knife unit 55 is 24 mm, and the offset amount Q of the distal end portion 56b of the knife 56 with respect to the blade axis D1 is 0.5 mm. In the case of FIG. 14 in which processing is advanced toward the +Y direction side (third direction) with respect to the workpiece medium S, the knife 56 rotates so that the blade edge surface 56a faces the +Y direction side, and the distal end portion 56b is at a position shifted by 0.5 mm toward the −Y direction side with respect to the blade axis D1. Then, in the Y-axis direction, a distance Lf from the position where the shaft center C1, which is the rotation center of the carriage 40, is disposed to the position where the distal end portion 56b of the knife 56 is disposed is 24.5 mm. In the case of FIG. 15 in which processing is advanced toward the −Y direction side (fourth direction) with respect to the workpiece medium S, the knife 56 rotates so that the blade edge surface 56a faces the −Y direction side, and the distal end portion 56b is at a position shifted by 0.5 mm toward the +Y direction side with respect to the blade axis D1. Then, in the Y-axis direction, a distance Ln from the position where the shaft center C1, which is the rotation center of the carriage 40, is disposed to the position where the distal end portion 56b of the knife 56 is disposed is 23.5 mm.

In a case where the height position of the shaft center C1 which is the rotation center of the second operation is set to be the same as the height position of the sheet surface S1, when the distance Ln and the distance Lf are different, a pressing load Fsn acting on the knife 56 from the torsion spring 33 in the case of the distance Ln and a pressing load Fsf acting on the knife 56 from the torsion spring 33 in the case of the distance Lf have different values. In order to improve the cutting accuracy, it is desirable to suppress the variation in the load on the knife 56 caused by the difference between the distance Ln and the distance Lf as much as possible.

FIGS. 14 and 15 are modifications in which the position of the rotation center (shaft center C1) of the second operation is adjusted in consideration of the case where the distance Ln and the distance Lf are different. As a setting in consideration of the influence of the offset of the distal end portion 56b of the knife 56 with respect to the blade axis D1, the height position of the shaft center C1, which is the rotation center of the second operation, is set below the height position of the sheet surface S1, that is, on the −Z direction side of the sheet surface S1. In other words, while the guide member 21 is disposed in one region (+Z direction side) with respect to the sheet surface S1 in the height direction (Z axis direction) perpendicular to the sheet surface S1, the shaft center C1 of the support shaft 25 and the support shaft 26 is disposed in the other region (−Z direction side) with respect to the sheet surface S1 in the height direction (Z axis direction) perpendicular to the sheet surface S1.

By setting the height position of the shaft center C1 on the −Z direction side with respect to the height position of the sheet surface S1, it is possible to reduce the difference between the pressing load Fsn and the pressing load Fsf while applying a constant torque from the torsion spring 33. This is because, contrary to the comparative example illustrated in FIG. 12 (configuration in which shaft center C2 which is a rotation center of the second operation is located on the +Z direction side with respect to sheet surface S1), when the cutting load Fc acts on the −Y direction side (FIG. 14), a force in a direction of causing the knife 56 to cut into the workpiece medium S acts on the carriage 40 rotatable about the shaft center C1, and when the cutting load Fc acts on the +Y direction side (FIG. 15), a force in a direction of releasing (keeping away) the knife 56 from the workpiece medium S acts on the carriage 40 rotatable about the shaft center C1. By the action of these forces, an effect of reducing the difference between the pressing load Fsn and the pressing load Fsf caused by the difference between the distance Ln and the distance Lf can be obtained. Furthermore, by appropriately setting the height position of the shaft center C1 on the −Z direction side with respect to the height position of the sheet surface S1, the pressing load Fsf and the pressing load Fsn can be substantially matched.

The height position of the shaft center C1 for matching the pressing load Fsn and the pressing load Fsf can be obtained by the following equation.

H=Tz(Ln−Lf)/(Fc(Ln+Lf))

H is a distance in the height direction from the sheet surface S1 to the shaft center C1, and particularly represents a shift amount of the shaft center C1 toward the −Z direction side with respect to the sheet surface S1. Tz is a required rotational torque (torque acting in a direction pressing the knife 56 against the workpiece medium S) generated by the torsion spring 33, and is a predetermined value corresponding to the specification of the torsion spring 33. Fc is a cutting load acting in the horizontal direction with respect to the knife 56 when cutting the workpiece medium S, and is a predetermined value corresponding to the material and thickness of the workpiece medium S. As long as the material and thickness of the workpiece medium S are constant, the cutting load Fc is substantially the same in both the case of causing the processing to proceed toward the +Y direction side with respect to the workpiece medium S and the case of causing the processing to proceed toward the −Y direction side with respect to the workpiece medium S.

As an example, the cutting load Fc at the time of cutting the workpiece medium S, which is the Kent paper having a thickness of 0.3 mm, was 8.1 N, and the required rotational torque Tz applied by the torsion spring 33 was 83.0 mmN. Substituting 23.5 mm for the distance Ln and 24.5 mm for the distance Lf in the above equation gives H≈−0.21 (mm). Therefore, the pressing load Fsn and the pressing load Fsf can be substantially matched by setting the shaft center C1 at a position shifted by about 0.21 mm from the height position of the sheet surface S1 toward the −Z direction side.

As described above, in a case where the processing unit includes the knife 56 having the single-edged structure while using the configuration (FIG. 13) in which the height position of the shaft center C1 is aligned with the height position of the sheet surface S1 as a reference, the effect of operating the processing unit with high accuracy can be improved by applying the adjustment of the height position of the shaft center C1 (FIGS. 14 and 15) in consideration of the influence of the offset of the distal end portion 56b of the knife 56 with respect to the blade axis D1.

As described above, the medium processing device 10 of the present embodiment has a simple structure of the processing-unit driving mechanism 20 that supports and operates the knife 56, which is a processing unit, and can suppress load fluctuation due to a difference in the conveyance direction of the workpiece medium S by the medium conveying mechanism 18, and can operate the knife 56 with high accuracy and stability.

Note that the type of processing performed on the workpiece medium S is not limited to cutting by the knife 56. For example, the knife holder 51 can be removed from the processing unit holder 50, and instead, the writing implement can be attached to the processing unit holder 50 to perform drawing processing using the writing tool on the workpiece medium S. Further, it is also possible to select a processing unit other than the knife or the writing implement and perform processing other than cutting and drawing on the workpiece medium S. It is also possible to adopt a configuration in which the processing unit holder 50 is removed from the holder attaching/detaching portion 40c of the carriage 40, and a processing unit such as a writing instrument is directly attached to the holder attaching/detaching portion 40c.

The above embodiments have been given as specific examples to facilitate understanding of the invention, and the present disclosure is not limited to these embodiments, and various modifications and changes can be made without departing from the gist of the invention.

In the medium processing device 10 of the above embodiment, the first direction (X-axis direction) in which the processing unit is moved by the processing-unit driving mechanism 20 and the second direction (Y-axis direction) in which the workpiece medium S is moved relative to the processing unit using the medium conveying mechanism 18 are set substantially perpendicular, but the first direction and the second direction can also be applied to a configuration in which the first direction and the second direction are not perpendicular to each other. That is, the first direction and the second direction may be directions intersecting each other.

In the medium processing device 10 of the above embodiment, the processing-unit driving mechanism 20 does not move the processing unit in the Y-axis direction (second direction) (except for a slight positional change in the Y-axis direction due to the rotation of the second operation), but moves the workpiece medium S in the Y-axis direction (second direction) by the medium conveying mechanism 18. However, means for relatively moving the workpiece medium S and the processing unit in the second direction is not limited to the configuration of the above embodiment, and the processing unit may be configured to move in the Y-axis direction (second direction). For example, the portion corresponding to the side plate 11a and the side plate 11b may be configured to be movable in the Y-axis direction, and the entire processing unit including the carriage 40 may be moved in the Y-axis direction. Therefore, the medium conveying mechanism 18 of the above embodiment is an example of a relative moving mechanism that relatively moves the workpiece medium S and the processing unit in the second direction, and a relative moving mechanism in a form other than this can also be applied.

In the medium processing device 10 of the above embodiment, the support shafts 25 and 26 are fixed to the connection plates 23 and 24 on both sides connecting the guide member 21 and the transmission member 22, and the support shafts 25 and 26 are rotatably supported by the bearings 27 and 28 provided on the side plates 11a and 11b on both sides of the main body 11. Unlike this configuration, a support shaft fixed (not rotating) to the side plates 11a and 11b of the main body 11 may be provided, and a shaft hole or a bearing (bearing) into which the support shaft is inserted may be provided in the connection plates 23 and 24. That is, the second operation of changing the height position of the processing unit (knife 56) from the sheet surface S1 may be either a configuration in which the support shaft itself rotates together with the transmission member 22, the carriage 40, and the like (the configuration of the above-described embodiment) or a configuration in which the transmission member 22, the carriage 40, and the like rotate relative to the support shaft without rotating the support shaft.

What is claimed is:

1. A medium processing device comprising:
a processing unit that presses and processes a sheet-like medium;
a processing-unit driving mechanism that can execute a first operation of moving the processing unit in a first direction along a sheet surface of the medium and a second operation of changing a height position of the processing unit from the sheet surface; and
a relative moving mechanism that relatively moves the medium with respect to the processing unit in a second direction intersecting the first direction, wherein
the processing-unit driving mechanism includes:
a guide member extending in the first direction, to which the processing unit is attached, and that guides the processing unit so as to be movable in the first direction; and
a support shaft disposed at a position closer to the medium than the guide member in a height direction perpendicular to the sheet surface and having the first direction as a shaft center, and
the second operation is set as an operation of integrally changing a height position of the processing unit from the sheet surface with the guide member along with rotation of the support shaft about the shaft center.

2. The medium processing device according to claim 1, wherein
a height position of the shaft center of the support shaft in the height direction is substantially the same as a height position of the sheet surface.

3. The medium processing device according to claim 1, wherein
the guide member is disposed in one region with respect to the sheet surface in the height direction, and
the shaft center of the support shaft is disposed in the other region with respect to the sheet surface in the height direction.

4. The medium processing device according to claim 3, wherein
a height position of the shaft center of the support shaft is a position at which a pressing load acting on the processing unit when processing is advanced toward a third direction side with respect to the medium and a pressing load acting on the processing unit when processing is advanced toward a fourth direction opposite to the third direction with respect to the medium substantially coincide with each other.

5. The medium processing device according to claim 1, wherein
the support shaft and the guide member are disposed at substantially the same position in the second direction.

6. The medium processing device according to claim 1, wherein
the support shaft is each arranged both sides of a medium supporting region where the medium is supported in the first direction.

7. The medium processing device according to claim 6, wherein
a main body supporting the processing-unit driving mechanism includes a pair of side plates disposed at intervals in the first direction, and
the support shaft is rotatably supported via bearings provided in the pair of side plates.

8. The medium processing device according to claim 6, wherein
the processing-unit driving mechanism includes:
a transmission member that extends in the first direction, rotates integrally with the guide member about the shaft center of the support shaft, and transmits rotation of the second operation to the processing unit; and
a pair of connecting members connecting the guide member and the transmission member at both ends in the first direction, and
each of the pair of connecting members includes the support shaft.
